(19) United States
(12) Patent Application Publication
(10) Pub. No.: US 2017/0331083 A1
(43) Pub. Date: Nov. 16, 2017

(54) BATTERY DEVICE

(71) Applicant: Robert Bosch GmbH, Stuttgart (DE)

(72) Inventors: Anja Koenig, Leinfelden-Echterdingen (DE); Chee Seng Loh, Pulau Pinang (MY); Constanze Sorhage, Leinfelden-Echterdingen (DE); Thilo Koeder, Gerlingen (DE); Wolf Zahn, Stuttgart (DE)

(21) Appl. No.: 15/526,066

(22) PCT Filed: Oct. 29, 2015
(86) PCT No.: PCT/EP2015/075063

§ 371 Date: May 11, 2017

(30) Foreign Application Priority Data
Dec. 2, 2014 (DE) 102014224575.3

(51) Int. Cl. H01M 2/10; B25F 5/02; H01M 10/0525

(52) U.S. Cl. CPC H01M 2/1066; H01M 10/0525; B25F 5/02; H01M 2/1055; H01M 2220/30

(57) ABSTRACT

A battery device, in particular a battery device for a hand-held power tool, is provided which includes at least one highly functional energy storage unit.

### BACKGROUND INFORMATION

A conventional battery device is already available.

### SUMMARY

The present invention is directed to a battery device.

A battery device, in particular a battery device for a hand-held power tool, is provided which includes at least one highly functional energy storage unit.

An existing installation space may thus be utilized in a particularly advantageous way. A particularly compact battery device may be provided. A particularly lightweight battery device may be provided. A particularly well-adapted battery device may be provided, depending on the application. A battery device with a particularly high operating voltage and/or with a particularly high operating current and/or with a particularly large capacity may be provided, depending on the application. In this context, a “battery device” is understood in particular to mean a device for temporarily storing electrical energy. The battery device is preferably provided for supplying energy to an electric machine, in particular a hand-held power tool. The battery device is preferably provided in particular for supplying energy to a drive unit of the electric machine. The battery device is preferably provided for being detachably connected to the electric machine, without using tools for the detachment. The battery device particularly preferably includes a housing, which in a connected state is only partially enclosed by a housing of the electric machine. In this context, an “energy storage unit” is understood in particular to mean a unit that is provided for storing and providing electrical energy. The energy storage unit preferably includes at least one electrochemical cell. The energy storage unit preferably has a rechargeable design. In this context, a “highly functional” energy storage unit is understood in particular to mean an energy storage unit having adapted performance parameters. The performance parameters are preferably adapted to an application. In this context, a “performance parameter” is understood in particular to mean a structural shape, a size, a gravimetric energy density, a gravimetric power density, and/or a voltage density. In this context, a “gravimetric density” is understood in particular to mean a variable that is based on mass. In this context, a “subunit” of an energy storage unit is understood in particular to mean a unit which is enclosed by a casing and which may be individually contacted.

In addition, it is provided that the at least one energy storage unit is designed as a highly integrated energy storage unit. A particularly high filling level of a storage area provided for the energy storage unit may be achieved in this way. In this context, a “highly integrated” energy storage unit is understood in particular to mean an energy storage unit whose dimensions and/or structural shape are/is adapted to an application, for example to dimensions of a storage area provided for the energy storage unit. In this context, a “filling level” is understood in particular to mean a ratio of a space occupied by the energy storage unit in an installed state to a space provided for an energy store.

In one advantageous embodiment, the at least one energy storage unit has a base surface whose shape is different from a circle. A particularly flexibly usable energy storage unit is provided in this way. A filling level may be further increased. In this context, a “base surface” is understood in particular to mean a surface, at an edge of a body, that corresponds to a cross section of the body at various distances from the edge, preferably at an arbitrary distance from the edge. The energy storage unit is preferably designed in the shape of a prism, and the base surface is preferably designed as a prism-shaped base surface. The energy storage unit is advantageously designed as a straight prism. The energy storage unit preferably has an at least essentially polygonal base surface. In this context, an “essentially polygonal” surface is understood in particular to mean a surface that differs from an exact polygonal surface by less than 10 percent, preferably by less than 5 percent, and particularly preferably by less than 2 percent, for example due to curved joinings of edges instead of corners. In one advantageous embodiment, the energy storage unit includes a plurality of subunits, each having a base surface whose shape is different from a circle. The energy store may be advantageously scaled in this way; i.e., a variable and/or performance parameter may be adapted. The subunits are advantageously designed in the shape of a prism in each case, preferably in the shape of a straight prism in each case. A particularly simple design of the energy storage unit may thus be achieved. In another advantageous embodiment, the base surface of the energy storage unit has a triangular design, or the energy storage unit includes at least one subunit having a triangular base surface. A space for an energy store may thus be designed in a particularly flexible manner. In another advantageous embodiment, the base surface has more than four edges, or the energy storage unit includes at least one subunit with a base surface having more than four edges. In one alternative embodiment, the base surface of the energy storage unit may have an at least essentially circular shape or an oval shape. In this way, the shape of the energy storage unit may be adapted to the space provided for an energy store in a particularly flexible manner. The energy storage unit advantageously includes two contact devices that are situated at two different edges. The contact devices are preferably situated at two different edges of the base surface. Particularly robust and short circuit-proof contacting of the energy storage unit may be achieved in this way. In one advantageous embodiment, the contact devices are situated at two mutually adjacent edges of the energy storage unit. In this way, an installation space for contacting may be utilized in a particularly advantageous manner. An installation space to be provided for the energy storage unit may be further reduced.

In addition, it is provided that the at least one energy storage unit includes at least two subunits having different sizes. In this way, the energy storage unit may be scaled in a particularly advantageous manner. Performance parameters of the energy storage unit may be changed particularly easily over a particularly wide range and/or adapted to an intended purpose. In one advantageous embodiment, the at least two subunits have volumes that differ from one another by at least 20 percent. A particularly flexibly adaptable energy storage unit may thus be provided. The volumes preferably differ from one another by at least 30 percent, and particularly preferably by at least 50 percent. The at least two subunits advantageously differ from one another by at least 20 percent in at least one direction of extension. An adaptation to an installation space may thus be further optimized. The at least two subunits preferably differ from one another by at least 30 percent and particularly preferably by at least 50 percent in at least one direction of extension.

In one advantageous embodiment, the at least one energy storage unit includes at least two subunits having different formations. An adaptation to a storage area that is provided for an energy store may thus be further optimized, and a dead volume may be avoided. In this context, “different formations” is understood in particular to mean different dimensional ratios. The subunits preferably have different geometric basic shapes, for example different prism shapes, that differ in particular in the number of edges of a base surface.

In addition, it is provided that the battery device includes a housing having at least two storage areas with different storage space dimensions, which in each case are provided for storage for a subunit of the at least one energy storage unit which is adapted to the particular storage area. A particularly high filling level of the storage area may be achieved in this way. The storage area is preferably delimited by the housing. In this context, “adapted” is understood in particular to mean that the subunit has a dimension in at least one spatial direction which corresponds to a dimension of the storage area in the spatial direction at a location provided for the subunit. The adapted subunit preferably has a dimension in each case in two spatial directions which corresponds to the respective dimensions of the storage area. The adapted subunit particularly preferably has a dimension in each case in three spatial directions which corresponds to the respective dimensions of the storage area. In an installed state, at least one surface of the adapted subunit is preferably in contact with a surface of the housing. Preferably at least two, and particularly preferably at least three, four, five, or six, surfaces of the adapted subunit are in contact in each case with a surface of the housing. In one advantageous embodiment, the energy storage unit has a base surface with a stepped edge. In this way, the base surface may be approximated to a curved contour of a storage area, and a filling level may be further increased.

In one advantageous embodiment, the battery device includes at least one functional element, which in an installed state is enclosed on at least two sides by the at least one energy storage unit. The functional element may thus be used in a particularly efficient manner. The functional element may be situated with particular protection. Damage to the functional element may be avoided. A particularly robust battery device may be provided. A location of the functional element may be established in a particularly flexible manner. An existing installation space may be utilized in a particularly advantageous manner. A “functional element” is understood to mean a component that is provided for detecting, changing, and/or regulating at least one operating parameter of the battery device. In one advantageous embodiment, the functional element is designed as a measuring element and/or control element. A high signal quality and/or control quality may thus be achieved. In this context, a measuring element and/or control element is understood in particular to mean a sensor, for example an NTC element, or a cooling element, heating element, and/or insulating element. It is possible for the functional element to be designed as an electronic unit and/or to include a circuit board. It is possible for the functional element to be provided for a data exchange, for example a wireless data exchange. It is possible for the functional element to be designed as a magnetic retaining element or storage element, for example for storage for one or multiple insertion tools or screws. In one advantageous embodiment, the battery device includes a housing shell that is spaced apart from the functional element. Point stresses in the housing shell and/or in housing elements may be avoided in this way. The battery device advantageously includes housing elements that are provided for accommodating the functional element. An additional installation space requirement for the functional element may thus be reduced or avoided. In this context, a housing element is understood in particular to mean an internal support element, a separating element, and/or a cell mounting.

The battery device advantageously includes a charging device that is provided for wirelessly transmitting energy into the at least one energy storage unit. In this way, a charging device may be situated in the housing of the battery device in a particularly space-saving manner. An increase in volume due to the charging device may be limited. A particularly convenient charging function may be provided. In this context, a charging device is understood in particular to mean a device that is provided for converting wirelessly transmitted energy into electric current for charging the energy storage unit. In this context, “wireless” energy transmission is understood in particular to mean electromagnetic, in particular inductive, energy transmission. In one advantageous embodiment, the charging device includes an induction coil. The induction coil is preferably designed as a secondary coil which is provided for cooperating with a primary coil, situated outside the housing of the battery device, for the wireless energy transmission.

In addition, it is provided that the at least one energy storage unit is designed as a high-efficiency energy storage unit. A required installation space for the energy storage unit may be further reduced in this way. A particularly lightweight battery device may be provided. A high level of user convenience may be achieved. In this context, a high-efficiency energy storage unit is understood in particular to mean an energy storage unit which in at least one operating mode has a gravimetric energy density of greater than 120 Wh/kg, preferably greater than 150 Wh/kg, and particularly preferably greater than 170 Wh/kg. In one advantageous embodiment, the energy storage unit in at least one operating mode has a gravimetric power density of 500 W/kg, preferably 540 W/kg, and particularly preferably 560 W/kg. In one advantageous embodiment, the energy storage unit has a low internal resistance. A parallel connection of energy storage units may thus be avoided. A compact battery device may be provided. A battery device for uses with a high power requirement may be provided.

In one advantageous embodiment, the at least one energy storage unit in at least one operating mode has a voltage density of at least 1.2 mV/mm³. A small minimum size of the battery device may thus be achieved. A particularly versatile battery device may be provided. A battery device for a wide range of applications may be provided. A particularly lightweight battery device may be provided. In this context, a “voltage density” is understood in particular to mean a ratio of a provided voltage to a volume occupied by the energy storage unit. The energy storage unit preferably has a voltage density of at least 1.2 mV/mm³, at least in an unloaded state. The energy storage unit preferably has a voltage density of at least 1.4 mV/mm³, particularly preferably at least 1.6 mV/mm³.

In addition, it is provided that the battery device has an operating voltage of at least 18 V, which is provided by the at least one energy storage unit in at least one operating mode. A battery device that is compact and at the same time powerful may thus be provided. A particularly lightweight battery device for uses with a minimum voltage requirement and a short operating period may be provided. A field of application of the battery device may be further expanded. In this context, an “operating voltage” is understood in particular to mean a nominal voltage whose value is between an end-of-charge voltage and an end-of-discharge voltage. The battery device preferably has an operating voltage of at least 24 V, preferably at least 30 V, and particularly preferably at least 36 V.

In one advantageous embodiment, the at least one energy storage unit includes a lithium-ion cell. A particularly long-lasting energy storage unit may thus be provided. In one advantageous embodiment, the lithium-ion cell is designed as a lithium polymer cell. An energy storage unit may thus be easily provided with a shape that is adapted to a storage area. The energy storage unit advantageously includes at least one pouch cell. A particularly lightweight energy storage unit may thus be provided. The energy storage unit may advantageously be scaled. An energy storage unit with a large number of electrochemical cells may be provided. Magnetizability of the casing may be limited. In this context, a “pouch cell” is understood to mean an electrochemical cell that includes a foil casing. The foil casing is preferably designed as an insulation-coated aluminum foil.

In one advantageous embodiment, the energy storage unit includes at least one casing which is at least essentially unmagnetizable. Parasitic effects during a wireless charging operation may thus be avoided. A particularly efficient wirelessly chargeable energy storage unit may be provided. In this context, a “casing” is understood in particular to mean an element that is provided for at least essentially completely enclosing an electrochemical cell. The casing preferably has an at least essentially leak-tight, in particular gas-tight, design. In this context, “at least essentially unmagnetizable” is understood in particular to mean diamagnetic or paramagnetic. In one advantageous embodiment, the energy storage unit includes a plurality of subunits, each including a casing that is at least essentially unmagnetizable. In one advantageous embodiment, the casing has a flexible design. A particularly simple installation operation may thus be achieved. In this context, “flexible” is understood in particular to mean at least locally nondestructively deformable, in particular partially elastically deformable.

In addition, a system which includes a hand-held power tool and a battery device according to the present invention is provided. In this way, a shape of the battery device may be aligned with an overall design for the system. A particularly compact system may be provided. A particularly lightweight system may be provided. A high level of user convenience may be achieved. In this context, a hand-held power tool is understood in particular to mean an electric hand-held power tool, for example a drill, a cordless screwdriver, a grinder, a saw, or a multifunction machine.

In addition, it is provided that the battery device includes a mechanical interface unit and an electrical interface unit for a detachable electrical and mechanical connection to the hand-held power tool. A replaceable battery device may thus be provided.

The battery device may be charged in a state in which it is detached from the hand-held power tool. A high level of user convenience may be achieved. It is possible for the battery device to be provided for being charged in a state in which it is connected to the hand-held power tool. It is possible for the hand-held power tool to be provided for being electrically connected to a power grid for a charging operation of the battery device.

In one advantageous embodiment, the system includes a replacement battery device which includes a mechanical interface unit and an electrical interface unit having a design that is analogous to the mechanical interface unit and the electrical interface unit of the battery device, as well as a design of the energy store that is different from the battery device. A particularly robust system may thus be provided. A wide range of applications of the system may be achieved. In this context, a “replacement battery device” is understood in particular to mean a device for temporarily storing electrical energy. The replacement battery device preferably has a design that is functionally equivalent to the battery device. In this context, a “different” design of the energy store is understood in particular to mean that the battery device and the replacement battery device include energy storage units with different geometric designs, different subunit designs, different arrangements of the subunits, and/or different types of electrochemical cells.

The battery device according to the present invention is not intended to be limited to the use and specific embodiment described above. In particular, for meeting a mode of operation described herein, the battery device according to the present invention may include a number of individual elements, components, and units that differ from the number stated herein.

### BRIEF DESCRIPTION OF THE DRAWINGS

Further advantages result from the following description of the figures. Seven exemplary embodiments of the present invention are illustrated in the figures. The figures and the description contain numerous features in combination. Those skilled in the art will also advantageously consider the features individually and combine them into further meaningful combinations.

FIG. 1 shows a system which includes a hand-held power tool and a battery device according to the present invention, in a side view.

FIG. 2 shows a schematic exploded illustration of the battery device.

FIG. 3 shows a schematic exploded illustration of a replacement battery device of the system.

FIG. 4 shows the battery device in a partial sectional side view along an insertion direction.

FIG. 5 shows the battery device in a partial sectional side view perpendicular to the insertion direction.

FIG. 6 shows one exemplary embodiment of a battery device with two compartments, in a partial sectional side view perpendicular to the insertion direction.

FIG. 7 shows one exemplary embodiment of a battery device with an alternative arrangement of a functional element, in a partial sectional side view perpendicular to the insertion direction.

FIG. 8 shows one exemplary embodiment of a battery device with a charging device, in a schematic exploded illustration.

FIG. 9 shows one exemplary embodiment of a battery device with an alternative shape of the housing.

FIG. 10 shows subunits of an energy storage unit of the battery device, in a side view.

FIG. 11 shows one exemplary embodiment of a battery device with a housing that includes three subunits offset at an angle, in a top view.

FIG. 12 shows one exemplary embodiment of a battery device with a housing that includes three pairs of subunits of an energy storage unit offset at an angle, in a top view.

### DETAILED DESCRIPTION OF EXAMPLE EMBODIMENTS

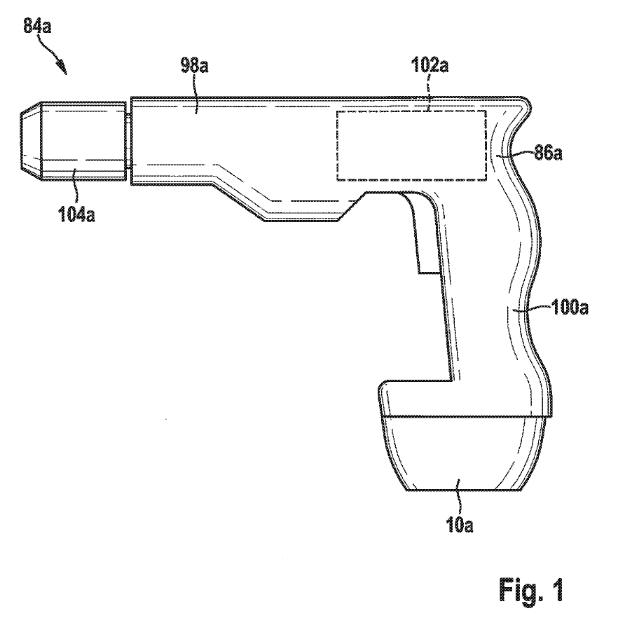

FIG. 1 shows a system 84a that includes a hand-held power tool 86a and a battery device 10a. Hand-held power tool 86a is designed as an electric hand-held power tool 86a. In the present exemplary embodiment, hand-held power tool 86a is designed as a cordless screwdriver. Hand-held power tool 86a includes a base body 98a and a handle 100a. Hand-held power tool 86a includes an electric drive unit 102a that is designed as an electric motor, and a tool receptacle 104a that is provided for accommodating an insertion tool, for example a screwdriver blade, not illustrated in greater detail. Handle 100a is situated at an angle with respect to base body 98a on one side of base body 98a. In an operating state, a user grips handle 100a with one or both hands and holds and/or guides hand-held power tool 86a.

Battery device 10a of system 84a is provided for storing energy and for supplying drive unit 102a of hand-held power tool 86a with electrical energy. It is possible for battery device 10a to be provided for supplying electrical energy to additional units of the hand-held power tool, such as a display and/or a control unit and/or regulation unit. Battery device 10a includes an energy storage unit 12a that is provided for storing electrical energy and supplying drive unit 102a of hand-held power tool 86a with electrical energy. Battery device 10a also includes a housing 56a that is provided for storing and protecting components of battery device 10a. In the present exemplary embodiment, housing 56a has an essentially cube-shaped design. Housing 56a is provided for storing and protecting energy storage unit 12a. In the present exemplary embodiment, housing 56a is made of a rigid plastic. Housing 56a has an essentially flat housing base side 106a. Housing 56a includes a housing cover 108a and a housing base 110a which form a housing shell 112a. It is possible for the housing to include a number of housing parts that is different from two. Housing shell 112a in an installed state encloses energy storage unit 12a. Housing shell 112a forms an outer casing of battery device 10a.

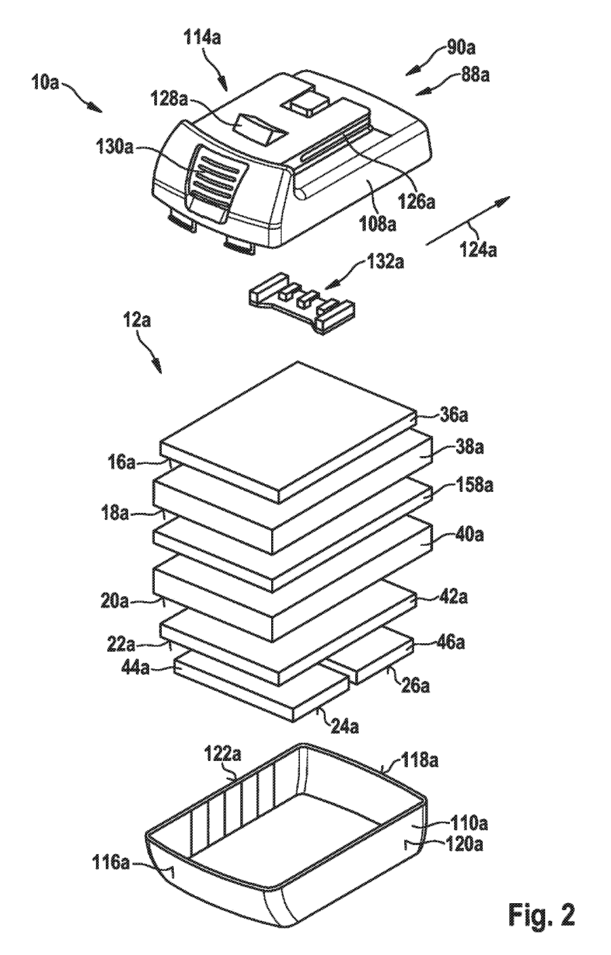

Battery device 10a includes a mechanical interface unit 88a and an electrical interface unit 90a for a detachable electrical and mechanical connection to hand-held power tool 86a (see FIG. 2). Interface units 88a, 90a are situated on an interface side 114a of battery device 10a opposite from housing base side 106a. Battery device 10a also has two end faces 116a, 118a and two side faces 120a, 122a. Handle 100a of hand-held power tool 86a has a receptacle that corresponds to interface units 88a, 90a of battery device 10a. Interface units 88a, 90a and the receptacle in handle 100a are provided for being joined together with the aid of an insertion movement. Battery device 10a has an insertion direction 124a. In the present exemplary embodiment, insertion direction 124a is oriented in parallel to housing base side 106a. Housing 56a has a step-shaped design on interface side 114a. In the present exemplary embodiment, at a step transition, housing 56a includes two guide elements 126a, each designed as a groove in insertion direction 124a. One of guide elements 126a is visible in FIG. 2. Interface units 88a, 90a have a shared insertion area that encloses the receptacle in handle 100a in a connected state. In the connected state, housing base side 106a, end faces 116a, 118a, and side faces 120a, 122a are exposed. Interface units 88a, 90a have an essentially mirror-symmetrical design, based on a plane perpendicular to interface side 114a.

Mechanical interface unit 88a includes a spring-loaded detent element 128a that is provided for locking battery device 10a in hand-held power tool 86a. Detent element 128a is pivotably supported on interface side 114a, and in a locked position protrudes beyond interface side 114a. Detent element 128a is provided for a form-locked connection to a corresponding element, not illustrated in greater detail, in the receptacle in handle 100a for battery device 10a. Interface unit 88a includes an unlocking element 130a. Unlocking element 130a is connected to detent element 128a, and is provided for pivoting detent element 128a against an elastic force and countersinking it into interface side 114a for unlocking. Battery device 10a is provided for being detached from hand-held power tool 86a, starting from a connected state, without tools and in a nondestructive manner.

Electrical interface unit 90a includes an electrical contact unit 132a, which in the present exemplary embodiment includes a plurality of contact springs. The receptacle in hand-held power tool 86a includes a corresponding contact unit, which in a connected state establishes electrical contact with contact unit 132a of interface unit 90a for transmitting electrical energy from battery device 10a to hand-held power tool 86a. It is possible for battery device 10a to include a display which is provided for displaying to the user a charging operation and/or a state of charge of battery device 10a, and which includes an LED or a plurality of LEDs, for example.

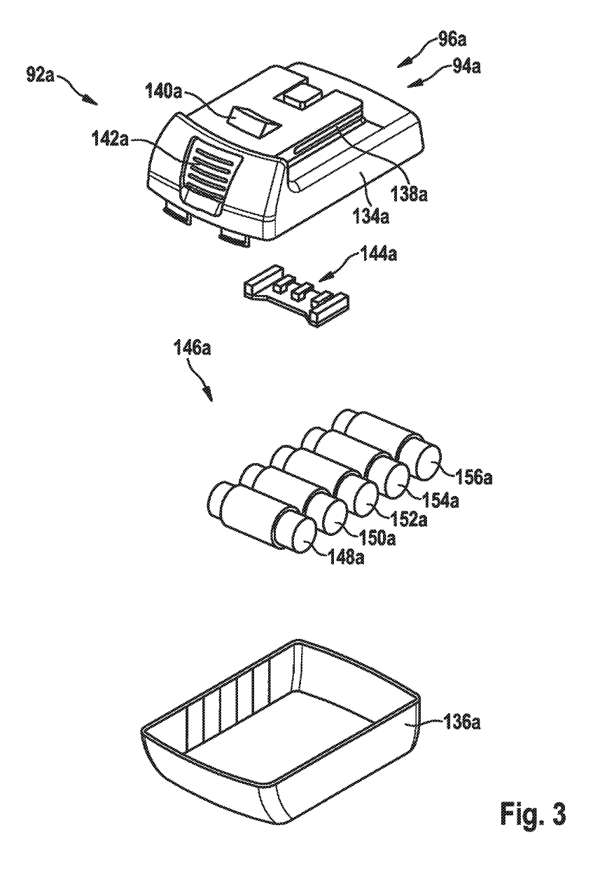

System 84a also includes a replacement battery device 92a that is provided for replacement of battery device 10a (see FIG. 3). Replacement battery device 92a is provided for connection, instead of battery device 10a, to hand-held power tool 86a. Replacement battery device 92a, similarly as for battery device 10a, includes a housing with a housing cover 134a and a housing base 136a. Replacement battery device 92a includes a mechanical interface unit 94a and an electrical interface unit 96a, having a design that is analogous to mechanical interface unit 88a and electrical interface unit 90a, respectively, of battery device 10a. Mechanical interface unit 94a includes two guide elements 138a, a detent element 140a, and an unlocking element 142a, having a design that is analogous to guide elements 126a, detent element 128a, and unlocking element 130a, respectively, of battery device 10a. Electrical interface unit 94a includes a contact unit 144a with a plurality of contact elements. Contact unit 144a has a design that is analogous to contact unit 132a of battery device 10a. Replacement battery device 92a includes an energy store with a design that is different from that of battery device 10a. Replacement battery device 92a includes an energy storage unit 146a. The design of energy storage unit 146a is different from that of energy storage unit 12a of battery device 10a. Energy storage unit 146a of replacement battery device 92a includes a plurality of subunits 148a-156a. Subunits 148a-156a have an analogous design with respect to one another. Subunits 148a-156a each include an electrochemical cell. Subunits 148a-156a have the same nominal voltage of 3.6 V. In the present exemplary embodiment, subunits 148a-156a are connected in series. Replacement battery device 92a has a nominal voltage of 18 V. Subunits 148a-156a have the same geometric shape. Subunits 148a-156a each have a round cell design, and have the same circular cylindrical shape.

Energy storage unit 12a of battery device 10a is designed as a highly functional energy storage unit 12a. Energy storage unit 12a is designed as a highly integrated energy storage unit 12a, and occupies 98 percent of the space provided for energy storage unit 12a. Energy storage unit 12a includes a plurality of subunits 36a-46a (see FIG. 2). Subunits 36a-46a each include an electrochemical cell. Subunits 36a-46a have the same nominal voltage of 3.6 V. In the present exemplary embodiment, energy storage unit 12a includes six subunits 36a-46a. Battery device 10a includes a control unit, not illustrated in greater detail, which is provided for controlling and/or monitoring charge currents and discharge currents. The control unit is designed as an electronic unit.

Subunits 36a-46a are each designed in the shape of a straight prism. Subunits 36a-46a each have a base surface 16a-26a. In the present exemplary embodiment, base surfaces 16a-26a each extend along a main direction of extension of subunits 36a-46a. Base surfaces 16a-26a of the various subunits 36a-46a are situated in parallel to one another. Base surfaces 16a-26a in an installed state are each oriented in parallel to housing base side 106a of battery device 10a. Subunits 36a-46a form a stack. The stack direction is oriented perpendicularly with respect to housing base side 106a. The stack includes a subunit 36a at the edge on a top side, and two subunits 44a, 46a at the edge on a bottom side. In an installed state, subunits 36a, 44a, 46a at the edge are each in flat contact with housing shell 112a along their main extension. It is possible for subunits 36a, 44a, 46a at the edge to be in flat contact with elements situated along housing shell 112a, for example functional elements such as sensors and/or control elements. It is also possible for base surfaces 16a-26a of subunits 36a-46a or of a portion of subunits 36a-46a to be situated perpendicularly with respect to housing base side 106a or at some other angle with respect to housing base side 106a. The shapes of base surfaces 16a-26a are each different from a circle. Base surfaces 16a-26a are each designed as a polygon. Base surfaces 16a-26a each have a rectangular design. Subunits 36a-46a are each designed in the shape of a flat cube. It is possible for energy storage unit 12a to include only one subunit, and thus to have only one base surface whose shape is different from a circle.

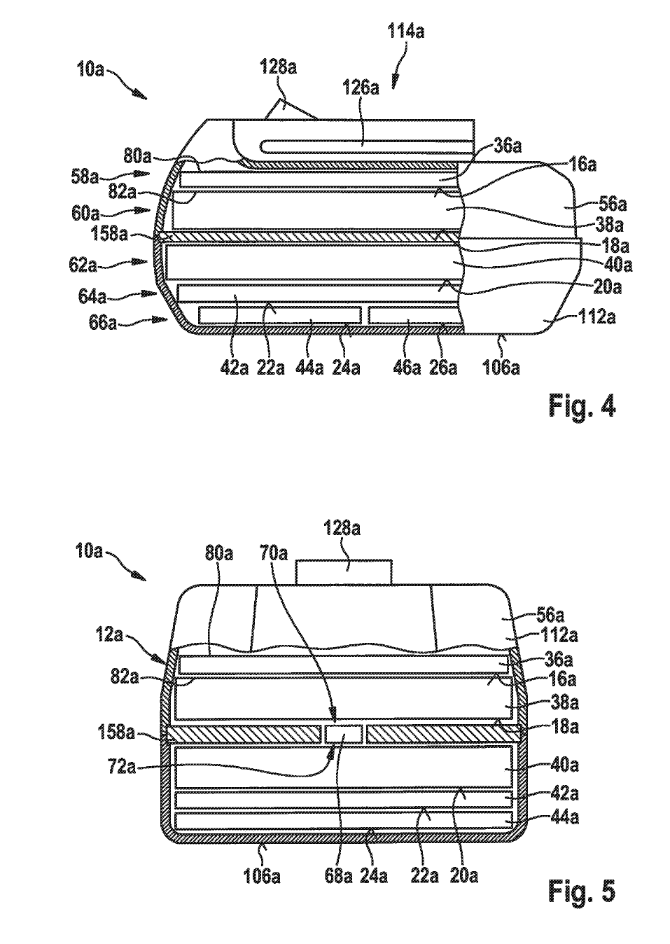

Subunits 36a-46a of energy storage unit 12a are each designed as a pouch cell. Subunits 36a-46a each include a flexible casing 80a, 82a (see FIG. 4). Subunits 36a-46a each have casings 80a, 82a with analogous designs with respect to one another, for which reason only a first subunit 36a and a further subunit 38a are described in greater detail below. Casings 80a, 82a are each provided for tightly enclosing a cell volume. Casings 80a, 82a each include a film composite having film layers made of different materials. In the present exemplary embodiment, casings 80a, 82a include a coated aluminum foil. Casings 80a, 82a each have a design that is locally deformable on a cell surface. Casings 80a, 82a are each provided for fitting tightly against a contact surface. Casings 80a, 82a are in each case essentially unmagnetizable. Casings 80a, 82a each have a paramagnetic design. Casing 80a of a subunit 36a and casing 82a of an adjacently situated subunit are in flat contact with one another in an installed state. It is possible for energy storage unit 12a to include a single subunit and a single casing.

Subunits 36a-46a of energy storage unit 12a have different sizes. Subunits 36a-46a have volumes of different sizes. In the present exemplary embodiment, a difference in the volumes between subunits 38a, 40a of a first size and subunits 36a, 42a of another size is approximately 60 percent. A difference between the volume of subunits 44a, 46a of a third size and of subunits 36a, 42a of the other size is approximately 55 percent, and between the volume of subunits 38a, 40a of the first size and of subunits 44a, 46a of the third size is approximately 80 percent. In the present exemplary embodiment, the subunits have the same width, a different length, and a different height. The lengths between the subunits 38a, 40a of the first size and of subunits 36a, 42a of the other size differ by approximately 15 percent. The heights differ from one another by approximately 55 percent. Subunits 36a, 38a, 40a, 42a thus differ from one another by approximately 55 percent in a direction of extension.

Housing 56a of battery device 10a includes a plurality of storage areas 58a-66a having different storage space dimensions, each being provided for storage for a subunit 36a-46a that is adapted to the particular storage area 58a-66a. In the present exemplary embodiment, housing 56a includes five storage areas 58a-66a having different storage space dimensions. A first of the storage areas 60a and another of the storage areas 62a are provided in each case for subunits 38a, 40a of the first size. Two other storage areas 58a, 64a are provided for subunits 36a, 42a of the second size. A fifth storage area 66a is situated on a base of battery device 10a, and is provided for two subunits 44a, 46a of the third size. Subunits 36a-46a are each adapted to the dimensions of storage areas 58a-62a for which they are provided.

Battery device 10a includes a functional element 68a. Functional element 68a is enclosed by two sides 70a, 72a of energy storage unit 12a in an installed state (see FIG. 5). In the present exemplary embodiment, functional element 68a is designed as a temperature sensor. Functional element 68a is designed as an NTC element, and is provided for detecting a temperature of energy storage unit 12a, for example in order to control a charge current or a discharge current or to notify the user of critical operating conditions. Functional element 68a is in contact with energy storage unit 12a at two opposite sides 70a, 72a. Functional element 68a is in contact with each of subunits 38a, 40a of energy storage unit 12a at two opposite sides 70a, 72a. Battery device 10a includes a cell mounting with a support element 158a. Support element 158a is designed in the shape of a plate. It is possible for support element 158a to be designed in one piece with housing cover 108a or housing base 110a. Support element 158a in an installed state is situated in parallel to housing base side 106a. Support element 158a has a recess 160a that is provided for functional element 68a. An extension of functional element 68a perpendicular to housing base side 106a corresponds to a height of support element 158a. Functional element 68a is centrally situated in battery device 10a. Functional element 68a is centrally situated, based on a direction in a support element plane perpendicular to insertion direction 124a of battery device 10a. It is also possible for functional element 68a to be situated off center, based on this direction. In an installed state, functional element 68a is spaced apart from housing shell 112a. Functional element 68a is spaced apart from housing cover 108a and from housing base 110a. Functional element 68a is situated at a distance from housing shell 112a in any spatial direction by greater than 10 percent, based on an interior extension of battery device 10a in the particular spatial direction. It is possible for a subunit 38a, 40a or a plurality of subunits 36a-46a situated adjacent to functional element 68a to have a recess in each case that is provided for accommodating the functional element. It is likewise possible for battery device 10a to include a plurality of functional element 68a, each of which in an installed state is enclosed by at least two sides of energy storage unit 12a.

Energy storage unit 12a is designed as a high-efficiency energy storage unit 12a. In an operating mode, energy storage unit 12a has a gravimetric energy density of approximately 146 Wh/kg. In an operating mode, energy storage unit 12a has a gravimetric power density of approximately 580 W/kg. In the operating mode, energy storage unit 12a has a voltage density of 1.2 mV/mm³. In the operating mode, battery device 10a has an operating voltage of approximately 18 V. Battery device 10a has an operating voltage of approximately 18 V in a charged state of energy storage unit 12a under average load. Battery device 10a is provided for supplying the operating voltage to electrical interface unit 90a. Battery device 10a is provided for supplying the operating voltage to an energy supply of drive unit 102a of hand-held power tool 86a. Subunits 36a-46a of energy storage unit 12a are each designed as a lithium-ion cell. Subunits 36a-46a are each designed as a lithium polymer cell. Subunits 36a-46a each have a nominal voltage of approximately 3.6 V.

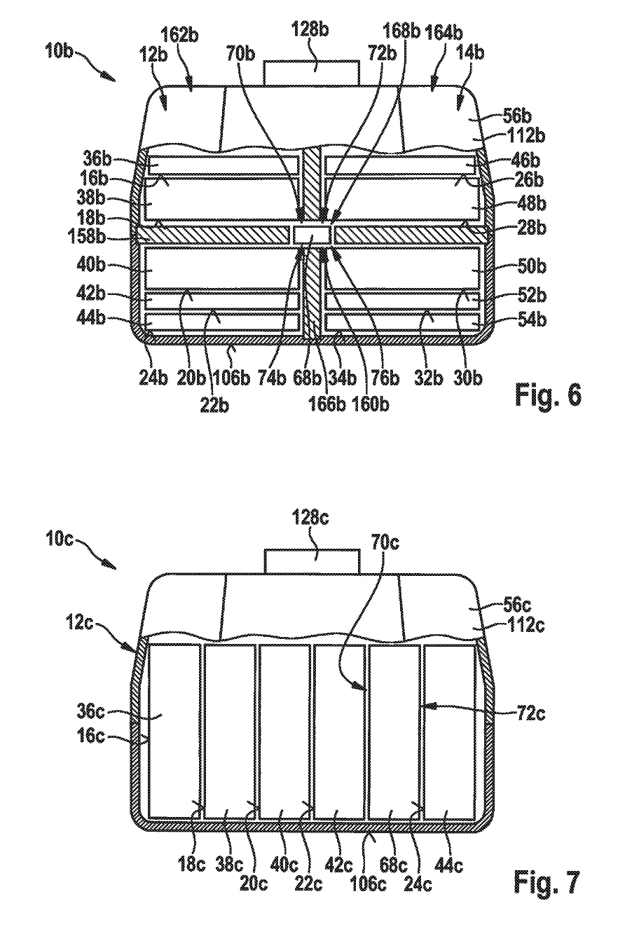

Further exemplary embodiments of the present invention are shown in FIGS. 6 through 12. The following descriptions and the drawings are limited essentially to the differences between the exemplary embodiments, whereby in principle, with regard to identically denoted components, in particular with regard to components having identical reference numerals, reference may also be made to the drawings and/or the description of the other exemplary embodiments, in particular in FIGS. 1 through 5. To distinguish between the exemplary embodiments, the letter a is added as a suffix to the reference numerals in the exemplary embodiment in FIGS. 1 through 5. The letter a is replaced by the letters b through g in the exemplary embodiments in FIGS. 6 through 12.

FIG. 6 shows a battery device 10b which includes an energy storage unit 12b and a further energy storage unit 14b. Similarly as for the preceding exemplary embodiment, battery device 10b is part of a system that includes a hand-held power tool. The hand-held power tool has a design that is analogous to the preceding exemplary embodiment. The energy storage units are provided for storing electrical energy and supplying a drive unit of the hand-held power tool with electrical energy. The battery device, similarly as for the preceding exemplary embodiment, includes a housing 56b that is provided for storing and protecting components of battery device 10b. Housing 56b is provided for storing and protecting energy storage units 12b, 14b. Housing 56b is made of a rigid plastic. Housing 56b includes an essentially flat housing base side 106b. Housing 56b includes a housing cover and a housing base which form a housing shell 112b. Battery device 10b includes a mechanical interface unit and an electrical interface unit for a detachable electrical and mechanical connection to the hand-held power tool. The mechanical interface unit includes a spring-loaded detent element 128b that is provided for locking battery device 10b in the hand-held power tool. Detent element 128b is pivotably supported, and in a locked position protrudes beyond housing 56b of battery device 10b.

Energy storage units 12b, 14b of battery device 10b are designed as highly functional energy storage units 12b, 14b. Energy storage units 12b, 14b are designed as highly integrated energy storage units 12b, 14b, and each occupy approximately 98 percent of the space provided for the particular energy storage unit 12b, 14b. Energy storage units 12b, 14b each include a plurality of subunits 36b-54b. In the present exemplary embodiment, the energy storage units each include five subunits 36b-54b. Energy storage units 12b, 14b, similarly as for the preceding exemplary embodiment, are designed as high-efficiency energy storage units 12b, 14b.

Subunits 36b-54b, similarly as for the preceding exemplary embodiment, each have a prism-shaped design. Subunits 36b-54b each have a base surface 16b-34b, which in an installed state is in each case oriented in parallel to housing base side 106b of battery device 10b. In contrast to the preceding exemplary embodiment, housing 56b includes two separate compartments 162b, 164b. In an installed state, energy storage units 12b, 14b are situated in compartments 162b, 164b, respectively. Subunits 36b-54b each form a stack. The stack directions are in parallel to one another. The stack directions are each perpendicular to housing base side 106b.

Subunits 36b-54b of energy storage units 12b, 14b, similarly as for the preceding exemplary embodiment, have different sizes. Subunits 36b-54b have volumes of different sizes. Subunits 36b-54b face away from one another at least in one direction of extension. Housing 56b of battery device 10b, similarly as for the preceding exemplary embodiment, includes a plurality of storage areas having different storage space dimensions, which in each case are provided for storage for a subunit 36b-54b which is adapted to the particular storage area.

Battery device 10b includes a functional element 68b. Functional element 68b in an installed state is enclosed by four sides 70b, 72b, 74b, 76b of energy storage units 12b, 14b. In the present exemplary embodiment, functional element 68b is designed as a temperature sensor. Functional element 68b is in contact with energy storage units 12b, 14b. Functional element 68b is enclosed by four sides 70b, 72b, 74b, 76b of subunits 38b, 40b, 48b, 50b of energy storage units 12b, 14b.

Battery device 10b includes a cell mounting which includes a horizontal support element 158b and a vertical support element 166b. Support elements 158b, 166b are each designed as a plate. It is possible for support elements 158b, 166b to each be designed in one piece with housing shell 112b. Vertical support element 166b has a plate plane that is perpendicular to housing base side 106b. Horizontal support element 158b has a plate plane that is in parallel to housing base side 106b. Support elements 158b, 166b have a recess 160b, 168b, respectively, that is provided for functional element 68b. Functional element 68b is centrally situated in battery device 10b. In the present exemplary embodiment, functional element 68b is situated in a plane of symmetry of battery device 10b. The plane of symmetry is perpendicular to housing base side 106b. It is possible for functional element 68b to be situated outside the plane of symmetry. It is likewise possible for only one of support elements 158b, 166b to have a recess for functional element 68b, and for functional element 68b to be spaced apart from the other support element. Functional element 68b in an installed state is spaced apart from housing shell 112b.

FIG. 7 shows another exemplary embodiment of a battery device 10c which includes an energy storage unit 12c. Similarly as for the preceding exemplary embodiment, battery device 10c is part of a system which includes a hand-held power tool. The hand-held power tool has a design that is analogous to the preceding exemplary embodiment. Energy storage unit 12c is provided for storing electrical energy and supplying a drive unit of the hand-held power tool with electrical energy. Battery device 10c, similarly as for the preceding exemplary embodiment, includes a housing 56c that is provided for storing and protecting components of battery device 10c. Housing 56c is provided for storing and protecting energy storage unit 12c. Housing 56c is made of a rigid plastic. Housing 56c has an essentially flat housing base side 106c. Housing 56c includes a housing cover and a housing base which form a housing shell 112c. Battery device 10c includes a mechanical interface unit and an electrical interface unit for a detachable electrical and mechanical connection to the hand-held power tool. The mechanical interface unit includes a spring-loaded detent element 128c that is provided for locking battery device 10c in the hand-held power tool. Detent element 128c is pivotably supported, and in a locked position protrudes beyond housing 56c of battery device 10c.

Energy storage unit 12c of battery device 10c is designed as a highly functional energy storage unit 12c. Energy storage unit 12c is designed as a highly integrated energy storage unit 12c. Energy storage unit 12c includes a plurality of subunits 36c-44c. In the present exemplary embodiment, energy storage unit 12c includes five subunits 36c-44c. Energy storage unit 12c, similarly as for the preceding exemplary embodiment, is designed as a high-efficiency energy storage unit 12c.

Subunits 36c-44c, similarly as for the preceding exemplary embodiment, each have a prism-shaped design. Subunits 36c-44c have a cube-shaped design. Subunits 36c-44c each have a base surface 16c-24c which, in contrast to the preceding exemplary embodiments, in an installed state in each case is oriented perpendicularly with respect to housing base side 106c of battery device 10c. Subunits 36c-44c form a stack. The stack direction is in parallel to housing base side 106c. In contrast to the preceding exemplary embodiments, subunits 36c-44c have an analogous design with respect to one another. Subunits 36c-44c have the same shape and the same volume.

Battery device 10c includes a functional element 68c. In an installed state, functional element 68c is enclosed by two sides 70c, 72c of energy storage unit 12c. In the present exemplary embodiment, functional element 68c is designed as a temperature sensor. Functional element 68c is in contact with each of subunits 36c-44c of energy storage unit 12c at two opposite sides 70c, 72c. In the present exemplary embodiment, the shape of functional element 68c corresponds to the shape of a subunit 36c-44c. Functional element 68c and subunits 36c-44c each have the same volumes and the same dimensions. It is possible for functional element 68c to have a volume that corresponds to a multiple of a volume of a subunit 36c-44c. For example, a space occupied by functional element 68c may correspond to a space occupied by two subunits 36c-44c. Functional element 68c is situated in the interior of the stack. It is possible for functional element 68c to be situated at an edge of the stack of subunits 36c-44c. In an installed state, functional element 68c is spaced apart from housing shell 112c on two sides, in one spatial direction. It is possible for energy storage unit 12c to include a plurality of stacks of subunits 36c-44c. It is also possible for functional element 68c to be enclosed by three, four, five, or six sides 70c, 72c of energy storage unit 12c. It is possible for functional element 68c to be spaced apart from the housing shell in each case on two sides 70c, 72c, in two spatial directions or in three spatial directions. It is possible for the battery device to include a plurality of functional elements 68c, which together or individually have a volume and a shape that in each case correspond to a volume and the shape of a subunit 36c-44c.

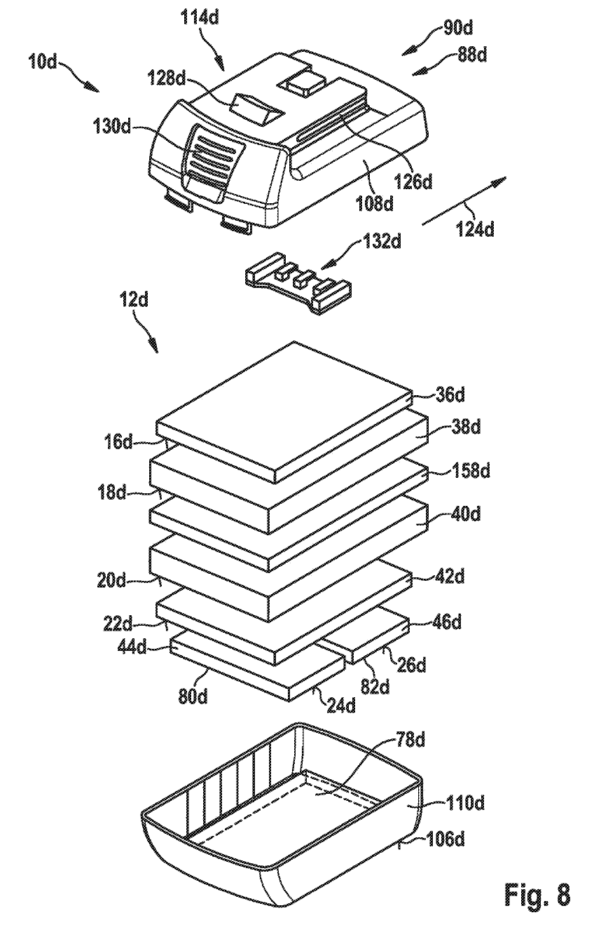

FIG. 8 shows another embodiment of a battery device 10d that is provided for storing energy and supplying the drive unit of a hand-held power tool with electrical energy. Battery device 10d includes an energy storage unit 12d that is provided for storing electrical energy and supplying a drive unit of the hand-held power tool with electrical energy. Battery device 10d, similarly as for the preceding exemplary embodiment, also includes a housing that is provided for storing and protecting components of battery device 10d. The housing is provided for storing and protecting energy storage unit 12d. In the present exemplary embodiment, the housing is made of a rigid plastic. The housing has an essentially flat housing base side 106d. The housing includes a housing cover 108d and a housing base 110d which form a housing shell. The housing shell in an installed state encloses the energy storage unit.

Battery device 10d includes a mechanical interface unit 88d and an electrical interface unit 90d for a detachable electrical and mechanical connection to the hand-held power tool. Interface units 88d, 90d are situated on an interface side 114d of battery device 10d opposite from the housing base side. Battery device 10d has an insertion direction 124d. In the present exemplary embodiment, insertion direction 124d is oriented in parallel to housing base side 106d. The housing has a step-shaped design on interface side 114d. In the present exemplary embodiment, at a step transition, the housing includes two guide elements 126d, each designed as a groove in insertion direction 124d. Interface unit 88d includes a spring-loaded detent element 128d that is provided for locking battery device 10d to the hand-held power tool. Interface unit 88d includes an unlocking element 130d. Unlocking element 130d is connected to detent element 128d, and is provided for pivoting detent element 128d against an elastic force and countersinking it into interface side 114d for unlocking. The interface unit includes an electrical contact unit 132d, which in the present exemplary embodiment includes contact elements designed as contact springs.

Energy storage unit 12d of battery device 10d, similarly as for the preceding exemplary embodiment, is designed as a highly functional energy storage unit 12d. Energy storage unit 12d is designed as a highly integrated energy storage unit 12d, and occupies approximately 98 percent of the space provided for energy storage unit 12d. Energy storage unit 12d, similarly as for the preceding exemplary embodiment, is designed as a high-efficiency energy storage unit 12d. Energy storage unit 12d includes a plurality of subunits 36d-46d. Subunits 36d-46d each have a prism-shaped design. Subunits 36d-46d each have a base surface 16d-26d. Base surfaces 16d-26d are each oriented in parallel to housing base side 106d of battery device 10d in an installed state. Battery device 10d includes a cell mounting that includes a support element 158d. Support element 158d is designed in the shape of a plate. Support element 158d in an installed state is in parallel to housing base side 106d.

Subunits 36d-46d of energy storage unit 12d are each designed as a pouch cell. Subunits 36d-46d each include a flexible casing 80d, 82d. Casings 80d, 82d of subunits 36d-46d have an analogous design with respect to one another, for which reason only the casings of a first subunit and of a further subunit are described in greater detail below. Casings 80d, 82d are each provided for tightly enclosing the cell volume. Casings 80d, 82d each have a design that is locally deformable. Casings 80d, 82d are each provided for fitting tightly against a contact surface. Casings 80d, 82d are in each case essentially unmagnetizable. Casings 80d, 82d each have a paramagnetic design.

Battery device 10d, in contrast to the preceding exemplary embodiments, includes a charging device 78d that is provided for wirelessly transmitting energy into the at least one energy storage unit 12d. In the present exemplary embodiment, charging device 78d includes an induction coil. The induction coil is designed as a secondary coil, and is provided for cooperating with a primary coil, not illustrated in greater detail, for wireless energy transmission, via which energy for a charging operation of energy storage unit 12d is transmitted into battery device 10d. In the present exemplary embodiment, charging device 78d is situated on housing base 110d. It is possible for charging device 78d to be situated on some other side of the housing. Charging device 78d has a flat design, and rests against housing base 110d. Subunits 36d-46d form a stack. The stack direction is oriented perpendicularly with respect to housing base side 106d. The stack includes a subunit 36d at the edge on a top side, and two subunits 44d, 46d at the edge on a bottom side. In an installed state, the two subunits 44d, 46d at the edge on a bottom side of the stack are in flat contact with charging device 78d. In the installed state, casings 80d, 82d of subunits 44d, 46d at the edge are in flat contact with charging device 78d.

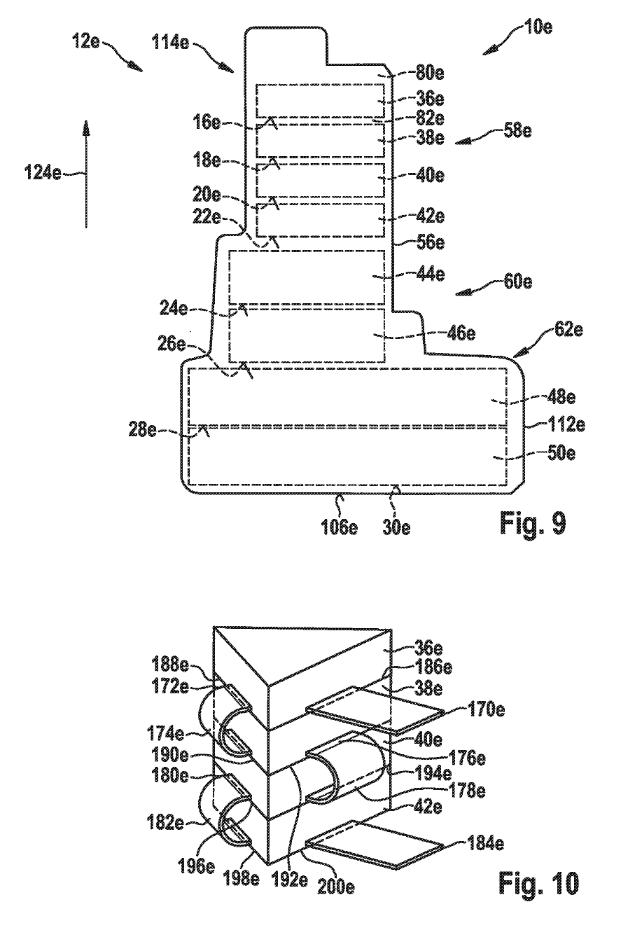

FIG. 9 shows another exemplary embodiment of battery device 10e. Battery device 10e, similarly as for the preceding exemplary embodiments, is designed as part of a system which includes a hand-held power tool, and is provided for storing energy and supplying the hand-held power tool with electrical energy. In contrast to the preceding exemplary embodiments, battery device 10e has a pedestal-shaped design. Battery device 10e includes a base, a central area, and a shank area. Battery device 10e includes an energy storage unit 12e that is provided for storing electrical energy and supplying a drive unit of the hand-held power tool with electrical energy. Battery device 10e also includes a housing 56e that is provided for storing and protecting components of battery device 10e. Housing 56e is provided for storing and protecting energy storage unit 12e. In the present exemplary embodiment, housing 56e is made of a rigid plastic. Housing 56e has an essentially flat housing base side 106e. Housing 56e also includes a housing shell 112e that encloses energy storage unit 12e in an installed state.

Battery device 10e, similarly as for the preceding exemplary embodiments, includes a mechanical interface unit and an electrical interface unit for a detachable electrical and mechanical connection to the hand-held power tool. The interface unit is situated on an interface side 114e of battery device 10e opposite from housing base side 106e. The handle of the hand-held power tool has a receptacle that corresponds to the interface unit of battery device 10e. The interface unit and the receptacle in the handle are provided for being joined together with the aid of an insertion movement. Battery device 10e has an insertion direction 124e. In contrast to the preceding exemplary embodiments, insertion direction 124e is oriented perpendicularly with respect to housing base side 106e. Housing 56e has guide elements, not illustrated in greater detail, that in each case are oriented essentially perpendicularly with respect to housing base side 106e.

Energy storage unit 12e of battery device 10e is designed as a highly functional energy storage unit 12e. Energy storage unit 12e is designed as a highly integrated energy storage unit 12e, and occupies approximately 98 percent of the space provided for energy storage unit 12e. Energy storage unit 12e is designed as a high-efficiency energy storage unit 12e. Energy storage unit 12e includes a plurality of subunits 36e-50e. In the present exemplary embodiment, energy storage unit 12e includes eight subunits 36e-50e.

Subunits 36e-50e each have a prism-shaped design. Subunits 36e-50e each have a base surface 16e-30e. Base surfaces 16e-30e each extend along a main direction of extension of subunits 36e-50e. Base surfaces 16e-30e of the various subunits 36e-50e are situated in parallel to one another in an installed state. Base surfaces 16e-30e are oriented in parallel to housing base side 106e of battery device 10e. Subunits 36e-50e form a stack. The stack direction is oriented perpendicularly with respect to housing base side 106e. The stack includes a subunit 36e at the edge on a top side, and a subunit 50e at the edge on a bottom side. In an installed state, subunits 36e, 50e at the edge are each in flat contact with housing shell 112e along their main extension.

The shapes of base surfaces 16e-30e are each different from a circle. Base surfaces 16e-30e are each designed as a polygon. Subunits 36e, 50e have different formations. Subunits 36e, 50e have three different formations. One group of subunits 48e, 50e is designed in the shape of a flat cube. Another group of subunits 44e-46e is designed in the shape of an elevated cube. A third group of subunits 36e-42e is designed in the shape of a general prism, and has a triangular base surface 16e-22e (see FIG. 10). Subunits 36e-50e of energy storage unit 12e have different sizes. Subunits 36e-50e have volumes of different sizes. In the present exemplary embodiment, subunits 36e-50e have different widths, different lengths, and different heights. In the present exemplary embodiment, subunits 36e-50e of a group are each connected in parallel to one another. The groups are connected in series. Subunits 36e-50e each have an operating voltage of 3.6 V. Battery device 10e has an operating voltage of 10.8 V. Subunits 36e-50e of energy storage unit 12e, similarly as for the preceding exemplary embodiments, are each designed as a pouch cell. Subunits 36e-50a each include a flexible casing 80e, 82e. Two of the casings 80e, 82e are provided with reference numerals in FIGS. 9 and 10. Casings 80e, 82e of subunits 36e-50e in each case have designs that are analogous to the casings of the subunits in the preceding exemplary embodiments.

Subunits 36e-50e each include two contact device 170e-184e that in each case are provided for an electrical connection to the particular subunit 36e-50e (see FIG. 10). Subunits 36e-50e each include at least two electrodes, each of which is electrically connected to one contact device 170e-184e in the interior of the particular casing 80e-82e. Contact devices 170e-184e are each provided for electrically contacting subunits 36e-50e, and have different electrical polarities. In the first group and the second group of subunits 44e-50e, contact devices 170e-184e are each routed out of the casing at the same edge of base surface 24e-30e. In the third group of subunits 36e-42e, contact devices 170e-184e are situated at two mutually adjacent edges. Contact devices 170e-184e are routed out of casing 80e, 82e at two mutually adjacent edges 186e-200e of base surface 16e-24e. In the present exemplary embodiment, subunits 36e-42e are connected in series with the aid of contact devices 172e-182e. In an installed state, each of contact devices 174e, 178e, 182e of a subunit 38e, 40e, 42e is connected to a contact device 172e, 176e, 180e of a subunit 36e, 38e, 40e situated above it. FIG. 10 shows subunits 36e-42e in an assembly step.

Housing 56e of battery device 10e includes a plurality of storage areas 58e-62e having different storage space dimensions, which in each case are provided for storage for a subunit 36e-50e which is adapted to the particular storage area 58e-62e. Storage areas 58e-62e have different shapes. In the present exemplary embodiment, housing 56e includes three storage areas 58e-62e having different storage space dimensions. Subunits 36e-50e are each adapted to the dimensions of storage areas 58e-62e for which they are provided.

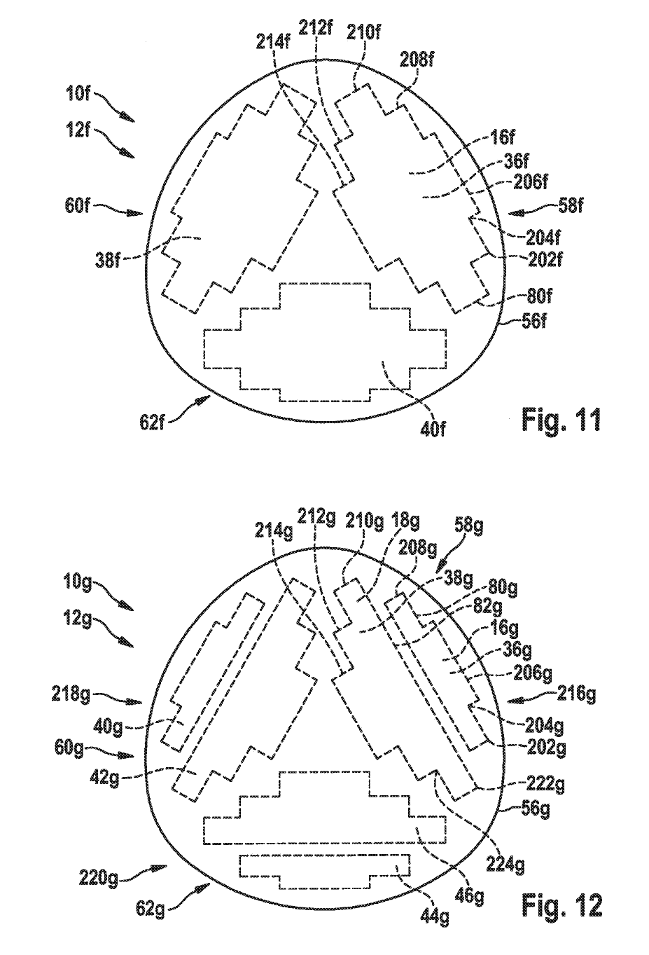

FIG. 11 shows another exemplary embodiment of battery device 10f. Battery device 10f, similarly as for the preceding exemplary embodiments, is designed as part of a system which includes a hand-held power tool, and is provided for storing energy and supplying the hand-held power tool with electrical energy. In the present exemplary embodiment, battery device 10f includes an energy storage unit 12f that is provided for storing electrical energy and supplying a drive unit of the hand-held power tool with electrical energy. Battery device 10f also includes a housing 56f that is provided for storing and protecting components of battery device 10f. Housing 56f is provided for storing and protecting energy storage unit 12f. In the present exemplary embodiment, housing 56f is made of a rigid plastic. In the present exemplary embodiment, housing 56f has an approximately threefold symmetry. Energy storage unit 12f includes three subunits 36f, 38f, 40f having an analogous design with respect to one another. A number of subunits 36f, 38f, 40f corresponds to a number of symmetrical positions of housing 56f. Battery device 10f includes a mechanical interface unit and an electrical interface unit, not illustrated in greater detail, for a detachable electrical and mechanical connection to the hand-held power tool. Energy storage unit 12f of battery device 10f is designed as a highly functional energy storage unit 12f. Energy storage unit 12f is designed as a high-efficiency energy storage unit 12f.

Subunits 36f, 38f, 40f are each designed in the shape of a straight prism. Subunits 36f, 38f, 40f have a base surface 16f, 18f, 20f, respectively. Subunits 36f, 38f, 40f have an analogous design with respect to one another, for which reason only a first of subunits 36f is described in greater detail below. Base surface 16f of subunit 36f has a mirror-symmetrical design, and has an axis of symmetry. Base surface 16f has a stepped edge.

Base surface 16f is designed as a concave polygon. Base surface 16f has twelve outwardly directed corners 202f and eight inwardly directed corners 204f. Outwardly directed corners 202f are situated on an oval. Inwardly directed corners 204f are situated on a further oval. Base surface 16f is made up of a plurality of adjoining flat rectangles 206f-214f. Base surface 16f is made up of five flat rectangles 206f-214f. Rectangles 206f-214f have different widths and lengths. A central rectangle 210f has a length which in each case is greater than the lengths of further rectangles 206f, 208f, 212f, 214f. Rectangles 206f, 214f at the edge each have a smaller length than respective adjacent rectangles 208f, 212f.

Subunit 36f is designed as a lithium-ion cell. Subunit 36f is designed as a pouch cell. Subunit 36f includes a plurality of layers of anodes, cathodes, separating elements, and collectors. The layers form a stack. In the present exemplary embodiment, the stack direction is in parallel to base surface 16f. The stack direction is situated in the direction of a width of rectangles 206f-214f which constitute base surface 16f. Subunit 36f includes a casing 80f. Casing 80f has a flexible design. Casing 80f is provided for tightly enclosing a cell volume. Casing 80f includes a foil composite having foil layers made of different materials. In the present exemplary embodiment, casing 80f includes a coated aluminum foil. The casing surface has a locally deformable design. Casing 80f is essentially unmagnetizable. Casing 80f has a paramagnetic design.

In an installed state, the axes of symmetry of base surfaces 16f, 18f, 20f intersect subunits 36f, 38f, 40f at a point of a cross section of battery device 10f. The axes of symmetry are in each case situated on one of the axes of symmetry of housing 56f. Subunits 36f, 38f, 40f are each situated in a rotation of 120 degrees with respect to one another.

Housing 56f of battery device 10f includes a plurality of storage areas 58f, 60f, 62f, each being provided for storage for a subunit 36f, 38f, 40f that is adapted to respective storage area 58f, 60f, 62f. In the present exemplary embodiment, storage areas 58f, 60f, 62f have the same shape. In the present exemplary embodiment, housing 56f includes three storage areas 58f, 60f, 62f having mutually corresponding dimensions. Subunits 36f, 38f, 40f are each adapted to the dimensions of storage areas 58f, 60f, 62f for which they are provided.

FIG. 12 shows another exemplary embodiment of battery device 10g. Battery device 10g, similarly as for the preceding exemplary embodiments, is designed as part of a system which includes a hand-held power tool, and is provided for storing energy and supplying the hand-held power tool with electrical energy. Battery device 10g, similarly as for the preceding exemplary embodiment, includes an energy storage unit 12g that is provided for storing electrical energy and supplying a drive unit of the hand-held power tool with electrical energy. The battery device, similarly as for the preceding exemplary embodiment, also includes a housing 56g that is provided for storing and protecting components of battery device 10g. Housing 56g has a design that is analogous to the preceding exemplary embodiment.

Energy storage unit 12g of battery device 10g is designed as a highly functional energy storage unit 12g. Energy storage unit 12g is designed as a high-efficiency energy storage unit 12g. Energy storage unit 12g, in contrast to the preceding exemplary embodiment, includes six subunits 36g-46g.

Battery device 10g includes three pairs 216g, 218g, 220g of subunits 36g-46g. Subunits 36g-46g are grouped in pairs. Pairs 216g, 218g, 220g each have an analogous design, for which reason only a first of the pairs 216g is described in greater detail below. Subunits 36g, 38g are each designed in the shape of a straight prism. Subunits 36g, 38g have a base surface 16g, 18g, respectively. Base surfaces 16g, 18g of subunits 36g, 38g each have a mirror-symmetrical design, and each have an axis of symmetry. Base surfaces 16g, 18g each have a stepped edge. Base surfaces 16g, 18g are each designed as a concave polygon. Base surface 16g, 18g of a first of subunits 36g has six outwardly directed corners 202g and two inwardly directed corners 204g. Base surface 18g of another of subunits 38g has eight outwardly directed corners 222g and four inwardly directed corners 224g. Base surfaces 16g, 18g are each made up of a plurality of adjoining flat rectangles 206g-214g. Base surface 16g of first subunit 36g is made up of two flat rectangles 206g, 208g. Base surface 18g of second subunit 38g is made up of three flat rectangles 210g, 212g, 214g. Rectangles 206g-214g have different widths and lengths. Each rectangle 208g, 210g at the edge has a length that in each case is greater than the lengths of the further rectangles. Each further rectangle 206g, 214g at the edge has a length that in each case is smaller than the lengths of further rectangles 208g-212g.

Subunits 36g, 38g are each designed as a lithium-ion cell. Subunits 36g, 38g are each designed as a pouch cell. Subunits 36g, 38g each include a plurality of layers of anodes, cathodes, separating elements, and collectors. The layers form a stack. In the present exemplary embodiment, the stack direction is in parallel to base surface 16g, 18g. The stack direction is situated in the direction of a width of rectangles 208g-212g which in each case constitute base surfaces 16g, 18g. Subunits 36g, 38g each include a casing 80g, 82g having a design that is analogous to the casing of the subunits in the preceding exemplary embodiment.

The axes of symmetry of base surfaces 16g, 18g of subunits 36g, 38g coincide in an installed state. The axes of symmetry of base surfaces 16g, 18g of subunits 36g, 38g intersect at a point. The axes of symmetry are each situated on one of the axes of symmetry of housing 56g. Pairs 216g, 218g, 220g are each situated in a rotation of 120 degrees with respect to one another.

Housing 56g of battery device 10g includes a plurality of storage areas 58g, 60g, 62g, each being provided for storage for subunits 36g-46g that is adapted to the particular storage area 58g, 60g, 62g. In the present exemplary embodiment, storage areas 58g, 60g, 62g have mutually corresponding shapes. In the present exemplary embodiment, housing 56g includes three storage areas 58g, 60g, 62g having mutually corresponding dimensions. Subunits 36g-46g are each adapted to the dimensions of storage areas 58g, 60g, 62g for which they are provided.

1-16. (canceled)

17. A battery device for a hand-held power tool, comprising:
at least one highly functional energy storage unit.

18. The battery device as recited in claim 17, wherein the at least one energy storage unit is designed as a highly integrated energy storage unit.

19. The battery device as recited in claim 17, wherein the at least one energy storage unit has a base surface whose shape is different from a circle.

20. The battery device as recited in claim 17, wherein the at least one energy storage unit includes at least two subunits having different sizes.

21. The battery device as recited in claim 17, wherein the at least one energy storage unit includes at least two subunits having different formations.

22. The battery device as recited in claim 17, further comprising
a housing that includes at least two storage areas having different storage space dimensions, each being provided for storage for a subunit of the at least one energy storage unit that is adapted to the particular storage area.

23. The battery device as recited in claim 17, further comprising:
at least one functional element which, in an installed state, is enclosed on at least two sides by the at least one energy storage unit.

24. The battery device as recited in claim 17, further comprising:
a charging device for wirelessly transmitting energy into the at least one energy storage unit.

25. The battery device as recited in claim 17, wherein the at least one energy storage unit is a high-efficiency energy storage unit.

26. The battery device as recited in claim 17, wherein the at least one energy storage unit has a voltage density of at least 1.2 mV/mm³ in at least one operating mode.

27. The battery device as recited in claim 17, wherein an operating voltage of at least 18 V, which is provided by the at least one energy storage unit in at least one operating mode.

28. The battery device as recited in claim 17, wherein the at least one energy storage unit includes a lithium-ion cell.

29. The battery device as recited in claim 17, wherein the energy storage unit includes at least one casing that is unmagnetizable.

30. A system, comprising:
a hand-held power tool; and
a battery device for the hand-held power tool, the battery device including at least one highly functional energy storage unit.

31. The system as recited in claim 30, wherein the battery device includes a mechanical interface unit and an electrical interface unit for a detachable electrical and mechanical connection to the hand-held power tool.

32. The system as recited in claim 31, further comprising:
a replacement battery device which includes a mechanical interface unit and an electrical interface unit having a design that is analogous to the mechanical interface unit and the electrical interface unit of the battery device, respectively, wherein a design of an energy store of the replacement battery device is different from the battery device.
